(19) United States
(12) Patent Application Publication
(10) Pub. No.: US 2022/0259464 A1
(43) Pub. Date: Aug. 18, 2022

(54) PRESSURE-SENSITIVE ADHESIVE COMPOUND WITH HIGH FILLER CONTENT

(71) Applicant: TESA SE, Norderstedt (DE)

(72) Inventors: Misin ZORNIC, Hamburg (DE); Li WANG, Hamburg (DE); Christoph JÜRGENS, Hamburg (DE)

(73) Assignee: TESA SE, Norderstedt (DE)

(21) Appl. No.: 17/622,989

(22) PCT Filed: Jun. 29, 2020
(86) PCT No.: PCT/EP2020/068310

§ 371 Date: Dec. 27, 2021

(30) Foreign Application Priority Data
Jun. 28, 2019 (DE) 10 2019 209 571.2

(51) Int. Cl. C09J 7/38; C09J 11/04; C09J 133/08; C08K 7/18; C08K 3/22; C08K 3/38

(52) U.S. Cl. CPC C09J 7/385; C09J 11/04; C09J 133/08; C08K 7/18; C08K 3/22; C08K 3/38; C08K 2201/003; C09J 2301/314; C09J 2301/408; C09J 2400/10; C09J 2433/00; C08K 2003/2227; C08K 2003/385; C09J 2301/302

(57) ABSTRACT

Pressure-sensitive adhesives (PSAs) and tapes comprising said PSAs are provided. The PSAs comprise at least one poly(meth)acrylate and at least 40% by volume, based on a total volume of the pressure-sensitive adhesive, of a mixture of at least two fillers. The mixture of at least two fillers comprises at least one filler Fiₛₚₕ comprising or consisting of essentially spherical particles and the PSAs may conduct heat and/or provide electrical resistivity for electronic device or component applications.

The invention relates to the technical field of pressure-sensitive adhesives as used for many years for the production of a wide variety of different adhesive bonds. More specifically, the invention relates to a pressure-sensitive adhesive having a very high filler content, which is notable for particularly good thermal conductivity.

Demands on pressure-sensitive adhesives and products equipped therewith have risen enormously in the last few years. Thus, attention no longer focuses solely on the adhesive performance but also on further properties such as chemical resistance, barrier function with respect to migrating substances, or else conductivity in relation to electrical current and/or thermal energy, the latter frequently also being referred to as thermal conductivity. In this context, thermal conductivity is increasingly important particularly for applications of pressure-sensitive adhesives in electronic devices or components. It is frequently important to dissipate the heat loss that arises in a device. This is conventionally done via dissipation plates, cooling surfaces, heatsinks, or by means of active cooling measures using fans. This prevents excessive heating of such devices and especially of the thermally sensitive assemblies and components present therein. The devices may then be operated within an admissible temperature range, especially also within a temperature range favorable in relation to the efficiency thereof. Moreover, this simply prevents the devices from becoming faulty as a result of overheating and failing.

On the other hand, it is also necessary in many cases to supply heat in order to assure impeccable functioning of the devices. Known instances include the transfer of thermal energy between two objects such as a heating element and an object to be heated, for example a heated mirror or a thermo-chuck, or the transfer of thermal energy from heated or cooled objects to a temperature sensor in order to enable process monitoring.

This is applicable, for example, to accumulators which generate a large amount of heat when charging rapidly and require cooling when a large amount of power is being drawn, in order to work optimally. Accumulators generally consist of multiple interconnected electrochemical assemblies, which in turn consist of single cells connected to a cooling plate. The connection between the cells and the cooling plate may be provided by an adhesive tape. It will be apparent that this adhesive tape need not interrupt the flow of heat, but must instead promote it.

In view of the trends to increase the proportion of electromobility that currently exist in the mobility sector, high-performance accumulators are becoming increasingly economically important. The accumulator is by far the most costly component in an electric car. Standard accumulators are irreparably damaged at temperatures of about 65° C. or more. For that reason, manufacturers are going to great efforts to prevent this and are using cooling systems that are in many cases even oversized in order to minimize the likelihood of damage to the accumulator.

The most commonly used accumulators at present are lithium-ion accumulators. The electrodes thereof are passivated with time even in normal operation, which fundamentally has an adverse effect on the performance and capacity of the accumulator. But the cells of these accumulators are constructed such that the electrode passivation can be substantially compensated for over the lifetime. This is usually accomplished by using more lithium ions from the outset than actually required in each cell.

Heating the lithium-ion accumulators to higher temperatures would greatly increase the coefficient of diffusion of the lithium ions both in the charging operation and in the discharging operation. This means that the diffusion rate of the lithium ions increases, which can firstly damage the separator layer of the cells. Secondly, there is greater passivation of the electrodes than in normal operation, which causes a distinct decrease in the power or capacity of the cell. Even overheating once can adversely affect the ion equilibrium established for the cell, because the amount of lithium ions used, calculated beforehand no longer corresponds to the actual circumstances at the electrodes.

On account of these processes, there is a great interest in efficiently removing heat released at the accumulators, and so this requirement also arises for adhesive components installed in the accumulators or used specially for the purpose of conduction of heat.

The prior art therefore discloses thermally conductive pressure-sensitive adhesives or adhesive tapes in many configurations.

For example, WO 2009/058630 A2 describes a thermally conductive adhesive comprising a tackifying polymer resin, a thermally conductive filler and a microhollow filler. The microhollow filler may form a porous structure and is therefore said, in combination with the thermally conductive filler, to endow an adhesive tape with excellent thermal conductivity and adhesive properties.

WO 2015/183896 A1 has a pressure-sensitive adhesive film for its subject matter, comprising a filler dispersed in an acrylate polymer matrix, wherein the filler has an average particle size less than the thickness of the pressure-sensitive adhesive film, and the filler is selected from graphite, boron nitride, aluminum oxide and zinc oxide.

EP 3 127 973 A1 describes a thermally conductive pressure-sensitive adhesive composition comprising an acrylate polymer component and a boron nitride composition, wherein the boron nitride composition comprises a first type of hexagonal primary boron nitride particle agglomerates having an average agglomerate size d₅₀ between 100 and 420 μm, and further optional hexagonal primary boron nitride particles or agglomerates thereof having different particle size; wherein the hexagonal boron nitride particles are in platelet form, the density of the first and optionally further agglomerates is between 0.3 and 2.2 g/cm³, and the proportion by volume of the boron nitride composition in the thermally conductive pressure-sensitive adhesive composition is more than 15% by volume.

EP 1 637571 A2 discloses a pressure-sensitive hotmelt adhesive characterized by a thermal conductivity of at least 0.15 W/K*m at 20° C. and at least 0.16 W/K*m at −30° C. The pressure-sensitive hotmelt adhesive may comprise thermally conductive fillers and/or pigments.

In the case of many pressure-sensitive adhesives known in the prior art, it has been found that it is frequently not possible to achieve a balanced profile of properties comprising adhesive performance, thermal and electrical conductivity, and producibility. It is an object of the invention to provide a pressure-sensitive adhesive that covers a broad spectrum of adhesive performance, and has efficient producibility and, in particular, excellent thermal conductivity. In addition, the adhesive is to have a maximum degree of electrically insulating properties.

A first and general subject of the invention is a pressure-sensitive adhesive which comprises
a. at least one poly(meth)acrylate; and
b. at least 40% by volume, based on the total volume of the pressure-sensitive adhesive, of a mixture of at least two fillers
   and is characterized in that the mixture of at least two fillers comprises at least one filler Fiₛₚₕ consisting of essentially spherical particles. As has been found, it is possible with such a pressure-sensitive adhesive to achieve widely distributed or widely adjustable bond strengths and good thermal conductivity—especially also in the z direction.

What is understood by a pressure-sensitive adhesive in accordance with the invention, as usual in general parlance, is a substance which, at least at room temperature, is permanently tacky and adhesive. The characteristic feature of a pressure-sensitive adhesive is that it can be applied to a substrate by pressure and remains stuck thereon, without specific definition of the pressure to be expended and the duration of action of this pressure. In general, but fundamentally depending on the exact nature of the pressure-sensitive adhesive, the temperature and air humidity, and the substrate, the action of a brief minimal pressure not extending beyond gentle contact for a brief moment is sufficient to achieve the bonding effect; in other cases, a longer contact time at a higher pressure may also be necessary.

Pressure-sensitive adhesives have characteristic viscoelastic properties that lead to sustained tackiness and adhesiveness. It is characteristic of these that, if they are mechanically deformed, there are both viscous flow processes and buildup of elastic resilience forces. The two processes are in a particular ratio to one another with regard to their respective proportions, depending both on the exact composition, the structure and the level of crosslinking of the pressure-sensitive adhesive and on the speed and duration of the deformation, and also on the temperature.

The viscous flow component is needed for achievement of adhesion. Only the viscous components, caused by macromolecules having relatively high mobility, enable good wetting and good adaptation to the surface to be bonded. A high proportion of viscous flow leads to high pressure-sensitive tack (also referred to as surface tack) and hence often also to a high bond strength. Highly crosslinked systems, crystalline polymers or polymers that have solidified in vitreous form, for lack of free-flowing components, are generally not tacky or at least only slightly tacky.

The elastic resilience force component is needed for achievement of cohesion. These forces are caused, for example, by very long-chain and highly entangled macromolecules, and by physically or chemically crosslinked macromolecules, and enable transfer of the forces that attack an adhesive bond. They have the effect that an adhesive bond can withstand a sustained stress that acts thereon, for example in the form of a sustained shear stress, to a sufficient degree over a prolonged period of time.

For more exact description and quantification of the degree of the elastic and viscous component, and of the ratio of the components to one another, the parameters of storage modulus (G′) and loss modulus (G″) that are determinable by means of dynamic-mechanical analysis (DMA) are cited. G′ is a measure of the elastic component, G″ a measure of the viscous component of a substance. The two parameters are dependent on the deformation frequency and temperature.

The parameters can be ascertained with the aid of a rheometer. The material to be examined is subjected here, for example in a plate-plate arrangement, to a sinusoidally oscillating shear stress. In shear stress-controlled instruments, deformation as a function of time, and the offset in this deformation over time with respect to the introduction of shear stress are measured. This offset over time is referred to as phase angle δ.

Storage modulus G′ is defined as follows: G′=(τ/γ)·cos(δ) (τ=shear stress, γ=deformation, δ=phase angle=phase shift between shear stress vector and deformation vector). The definition of loss modulus G″ is: G″=(τ/γ)·sin)(δ) (τ=shear stress, γ=deformation, δ=phase angle=phase shift between shear stress vector and deformation vector).

An adhesive is considered to be a pressure-sensitive adhesive especially when, at 23° C., in the deformation frequency range from 10⁰ to 10¹ rad/sec, both G′ and G″ are at least partly within the range from 10³ to 10⁷ Pa. What is meant by “partly” is that at least a section of the G′ curve is within the window defined by the deformation frequency range from 10⁰ to 10¹ rad/sec inclusive (abscissa) and the range of G′ values from 10³ to 10⁷ Pa inclusive (ordinate). The same applies to the G″ curve.

A “poly(meth)acrylate” is understood to mean a polymer obtainable by free radical polymerization of acrylic monomers and/or methacryl monomers and optionally further copolymerizable monomers. More particularly, a “poly(meth)acrylate” is understood to mean a polymer having a monomer basis consisting to an extent of at least 50% by weight of acrylic acid, methacrylic acid, acrylic esters and/or methacrylic esters, where acrylic esters and/or methacrylic esters are present at least in part, preferably to an extent of at least 30% by weight, based on the overall monomer basis of the polymer in question.

The pressure-sensitive adhesive of the invention preferably comprises poly(meth)acrylates in a total amount of 10% to 30% by weight, more preferably in a total amount of 12% to 25% by weight, based in each case on the total weight of the pressure-sensitive adhesive. It is possible for a (single) poly(meth)acrylate or multiple poly(meth)acrylates to be present. Where reference is made above and hereinafter to “the poly(meth)acrylate”, this shall always also include the presence of multiple poly(meth)acrylates; similarly, where reference is made to “the poly(meth)acrylates” or “the totality of all poly(meth)acrylates”, the presence of just a single poly(meth)acrylate shall also be included.

The glass transition temperature of the poly(meth)acrylate in the pressure-sensitive adhesive of the invention is preferably <0° C., more preferably between −25 and −70° C. The glass transition temperature of polymers or of polymer blocks in block copolymers is determined in accordance with the invention by means of dynamic scanning calorimetry (DSC). For this purpose, about 5 mg of an untreated polymer sample is weighed into an aluminum boat (volume 25 μl) and closed with a punctured lid. The measurement is made using a DSC 204 F1 from Netzsch. A nitrogen atmosphere is employed for inertization. The sample is first cooled down to −150° C., then heated up to +150° C. at a heating rate of 10 K/min and cooled down again to −150° C. The subsequent second heating curve is run again at 10 K/min and the changing heat capacity is recorded. Glass transitions are recognized as steps in the thermogram.

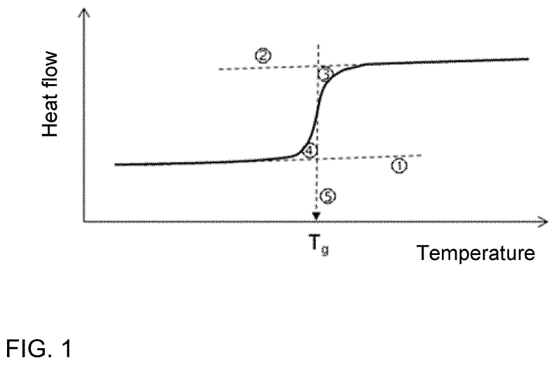

The glass transition temperature is obtained as follows (see FIG. 1):

The respective linear region of the measurement curve before and after the step is extended in the direction of rising temperatures (area before the step) or falling temperatures (area after the step) (tangents and \textcircled{2}). In the region of the step, a line of best fit \textcircled{5} is run parallel to the ordinate such that it intersects with both tangents, specifically in such a way as to form two equal areas \textcircled{3} and \textcircled{4} (between the respective tangent, the line of best fit and the measurement curve). The point of intersection of the line of best fit thus positioned with the measurement curve gives the glass transition temperature.

The poly(meth)acrylate in the pressure-sensitive adhesive of the invention preferably comprises at least one partly polymerized functional monomer which is more preferably reactive with epoxy groups to form a covalent bond. Most preferably, the partly copolymerized functional monomer which is more preferably reactive with epoxy groups to form a covalent bond contains at least one functional group selected from the group consisting of carboxylic acid groups, sulfonic acid groups, phosphonic acid groups, hydroxy groups, acid anhydrides groups, epoxy groups and amino groups; it especially contains at least one carboxylic acid group. Extremely preferably, the poly(meth)acrylate in the pressure-sensitive adhesive of the invention contains partly polymerized acrylic acid and/or methacrylic acid. All the groups mentioned have reactivity with epoxy groups, which means that the poly(meth)acrylate is advantageously amenable to thermal crosslinking with introduced epoxides.

The poly(meth)acrylate in the pressure-sensitive adhesive of the invention may preferably be based on the following monomer composition:
a) at least one acrylic ester and/or methacrylic ester of the following formula (1):

CH₂═C(R^{I})(COOR^{II}) (1)

in which R^{I}═H or CH₃ and R^{II} is an alkyl radical having 4 to 18 carbon atoms;
b) at least one olefinically unsaturated monomer having at least one functional group selected from the group consisting of carboxylic acid groups, sulfonic acid groups, phosphonic acid groups, hydroxy groups, acid anhydride groups, epoxy groups and amino groups;
c) optionally further acrylic esters and/or methacrylic esters and/or olefinically unsaturated monomers copolymerizable with component (a).

It is particularly advantageous to choose the monomers of component a) with a proportion of 45% to 99% by weight, the monomers of component b) with a proportion of 1% to 15% by weight and the monomers of component c) with a proportion of 0% to 40% by weight, where the figures are based on the monomer mixture for the base polymer without additions of any additives such as resins etc.

The monomers of component a) are generally plasticizing, comparatively nonpolar monomers. More preferably, R^{I} in the monomers a) is an alkyl radical having 4 to 10 carbon atoms or 2-propylheptyl acrylate or 2-propylheptyl methacrylate. The monomers of the formula (1) are especially selected from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate, 2-ethylhexyl methacrylate, 2-propylheptyl acrylate and 2-propylheptyl methacrylate.

The monomers of component b) are more preferably selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, especially 2-hydroxyethyl acrylate, hydroxypropyl acrylate, especially 3-hydroxypropyl acrylate, hydroxybutyl acrylate, especially 4-hydroxybutyl acrylate, hydroxyhexyl acrylate, especially 6-hydroxyhexyl acrylate, hydroxyethyl methacrylate, especially 2-hydroxyethyl methacrylate, hydroxypropyl methacrylate, especially 3-hydroxypropyl methacrylate, hydroxybutyl methacrylate, especially 4-hydroxybutyl methacrylate, hydroxyhexyl methacrylate, especially 6-hydroxyhexyl methacrylate, allyl alcohol, glycidyl acrylate, glycidyl methacrylate.

Illustrative monomers of component c) are:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyl-adamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxy diethylene glycol methacrylate, ethoxy triethylene glycol methacrylate, octafluoropentyl acrylate, octafluoropentyl methacrylate, 2,2,2-trifluoro-ethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methylundecyl)-acrylamide, N-(n-butoxymethyl)acrylamide, N-(butoxymethyl)methacrylamide, N-(ethoxymethyl)acrylamide, N-(n-octadecyl)acrylamide; N,N-dialkyl-substituted amides, for example N,N-dimethylacrylamide and N,N-dimethylmethacrylamide; N-benzylacrylamide, N-isopropylacrylamide, N-tert-butylacrylamide, N-tert-octylacrylamide, N-methylolacrylamide, N-methylolmethacrylamide, acrylonitrile, methacrylonitrile; vinyl ethers such as vinyl methyl ether, ethyl vinyl ether, vinyl isobutyl ether; vinyl esters such as vinyl acetate; vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene; macromonomers such as 2-polystyreneethyl methacrylate (weight-average molecular weight Mw, determined by GPC, of 4000 to 13000 g/mol), poly(methyl methacrylate)ethyl methacrylate (Mw of 2000 to 8000 g/mol).

Monomers of component c) may advantageously also be chosen such that they contain functional groups that assist subsequent radiochemical crosslinking (for example by electron beams, UV). Suitable copolymerizable photoinitiators are, for example, benzoin acrylate and acrylate-functionalized benzophenone derivatives. Monomers that assist crosslinking by electron bombardment are, for example, tetrahydrofurfuryl acrylate, N-tert-butylacrylamide and allyl acrylate.

More preferably, the poly(meth)acrylate in the pressure-sensitive adhesive of the invention is based on a monomer composition consisting of acrylic acid, n-butyl acrylate and 2-ethylhexyl acrylate.

The preparation of the poly(meth)acrylates is preferably accomplished by conventional free-radical polymerizations or controlled free-radical polymerizations. The poly(meth)acrylates can be prepared by copolymerization of the monomers using customary polymerization initiators and optionally chain transfer agents, by polymerization at the customary temperatures in bulk, in emulsion, for example in water or liquid hydrocarbons, or in solution.

The poly(meth)acrylates are preferably prepared by copolymerizing the monomers in solvents, more preferably in solvents having a boiling range of 50 to 150° C., especially of 60 to 120° C., using 0.01% to 5% by weight, especially 0.1% to 2% by weight, based in each case on the total weight of the monomers, of polymerization initiators.

All customary initiators are suitable in principle. Examples of free-radical sources are peroxides, hydroperoxides and azo compounds, for example dibenzoyl peroxide, cumene hydroperoxide, cyclohexanone peroxide, di-t-butyl peroxide, cyclohexylsulfonylacetyl peroxide, diisopropyl percarbonate, t-butyl peroctoate and benzopinacol. Preferred free-radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the preparation of the poly(meth)acrylates are alcohols such as methanol, ethanol, n- and isopropanol, n- and isobutanol, especially isopropanol and/or isobutanol; hydrocarbons such as toluene and especially benzine with a boiling range from 60 to 120° C.; ketones, especially acetone, methyl ethyl ketone, methyl isobutyl ketone, esters such as ethyl acetate, and mixtures of the aforementioned solvents. Particularly preferred solvents are mixtures containing isopropanol in amounts of 2% to 15% by weight, especially of 3% to 10% by weight, based in each case on the solvent mixture used.

The production (polymerization) of the poly(meth)acrylates is preferably followed by a concentration step, and the further processing of the poly(meth)acrylates is essentially solvent-free. The concentration of the polymer can be accomplished in the absence of crosslinker and accelerator substances. But it is also possible to add one of these compound classes to the polymer even before the concentration, such that the concentration is then effected in the presence of this/these substance(s).

After the concentration step, the polymers can be transferred to a compounder. The concentration and compounding may optionally also take place in the same reactor.

The weight-average molecular weights M_{w} of the polyacrylates are preferably within a range from 20000 to 2000000 g/mol; very preferably within a range from 100000 to 1500000 g/mol, exceptionally preferably within a range from 150000 to 1000000 g/mol. For this purpose, it may be advantageous to conduct the polymerization in the presence of suitable chain transfer agents such as thiols, halogen compounds and/or alcohols in order to establish the desired average molecular weight.

The number-average molar mass Mₙ and weight-average molar mass M_{w} figures in this document relate to determination by gel permeation chromatography (GPC), which is known per se. The determination is effected on a 100 μl clear-filtered sample (sample concentration 4 g/l). The eluent used is tetrahydrofuran with 0.1% by volume of trifluoroacetic acid. The measurement is effected at 25° C.

The pre-column used is a column of the PSS-SDV type, 5 μm, 10³ Å, 8.0 mm*50 mm (figures here and hereinafter in the following sequence: type, particle size, porosity, internal diameter*length; 1 Å=10⁻¹⁰ m). Separation is accomplished using a combination of columns of the PSS-SDV type, 5 μm, 10³ Å, and 10⁵ Å and 10⁶ Å, each with 8.0 mm*300 mm (columns from Polymer Standards Service; detection by means of Shodex RI71 differential refractometer).

The flow rate is 1.0 ml per minute. Calibration in the case of poly(meth)acrylates is against PMMA standards (polymethylmethacrylate calibration) and otherwise (resins, elastomers) against PS standards (polystyrene calibration).

The poly(meth)acrylates preferably have a K value of 30 to 90, more preferably of 40 to 70, measured in toluene (1% solution, 21° C.). Fikentscher's K value is a measure of the molecular weight and viscosity of polymers.

The principle of the method is based on the determination of the relative solution viscosity by capillary viscometry. For this purpose, the test substance is dissolved in toluene by shaking for 30 minutes, so as to obtain a 1% solution. In a Vogel-Ossag viscometer, at 25° C., the flow time is measured and this is used to determine the relative viscosity of the sample solution with respect to the viscosity of the pure solvent. According to Fikentscher [P. E. Hinkamp, Polymer, 1967, 8, 381], it is possible to read off the K value from tables (K=1000 k).

The poly(meth)acrylates in the pressure-sensitive adhesive of the invention preferably have a polydispersity PD<5 and hence a relatively narrow molecular weight distribution. Adhesives based thereon, in spite of a relatively low molecular weight after crosslinking, have particularly good shear strength. Moreover, the relatively low polydispersity enables easier processing from the melt since the flow viscosity is lower compared to a poly(meth)acrylate of broader distribution with largely the same application properties. Poly(meth)acrylates having a narrow distribution can advantageously be prepared by anionic polymerization or by controlled free-radical polymerization methods, the latter being of particular good suitability. It is also possible to prepare corresponding poly(meth)acrylates via N-oxyls. In addition, it is advantageously possible to use atom transfer radical polymerization (ATRP) for synthesis of narrow-distribution poly(meth)acrylates, preferably using monofunctional or difunctional, secondary or tertiary halides as initiator, and complexes of Cu, Ni, Fe, Pd, Pt, Ru, Os, Rh, Co, Ir, Ag or Au for abstraction of the halides. RAFT polymerization is also suitable.

The poly(meth)acrylates in the pressure-sensitive adhesive of the invention are preferably crosslinked by linkage reactions—especially in the form of addition or substitution reactions—of functional groups present therein with thermal crosslinkers. It is possible to use any thermal crosslinkers which
both assure a sufficiently long processing time, such that there is no gelation during the processing operation, especially the extrusion operation,
and also lead to rapid post-crosslinking of the polymer to the desired level of crosslinking at lower temperatures than the processing temperature, especially at room temperature.

One possible example are polymers containing a combination of carboxy, amino and/or hydroxy groups, and crosslinkers having cyclic ether functions and/or reactive silyl groups.

Preference is given to using thermal crosslinkers in an amount of 0.1% to 5% by weight, especially in an amount of 0.2% to 1% by weight, based on the total amount of the polymers to be crosslinked.

Crosslinking via complexing agents, also referred to as chelates, is also possible. An example of a preferred complexing agent is aluminum acetylacetonate.

The poly(meth)acrylates in the pressure-sensitive adhesive of the invention are preferably crosslinked by means of at least one substance containing at least two epoxy groups (epoxy compounds). The result is accordingly indirect linkage of the units of the poly(meth)acrylates that bear the functional groups that are reactive with the epoxy groups. The substances containing epoxy groups may either be aromatic or aliphatic compounds.

Preferred epoxy compounds are oligomers of epichlorohydrin; epoxy ethers of polyhydric alcohols, especially of ethylene glycol, propylene glycol and butylene glycol, polyglycols, thiodiglycols, glycerol, pentaerythritol, sorbitol, polyvinylalcohol and polyallylalcohol; epoxy ethers of polyhydric phenols, especially of resorcinol, hydroquinone, bis(4-hydroxyphenyl)-methane, bis(4-hydroxy-3-methylphenyl)methane, bis(4-hydroxy-3,5-dibromophenyl)-methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxyphenyl)phenylmethane, bis(4-hydroxyphenyl)-phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl)methane, 1,1-bis(4-hydroxyphenyl)cyclohexane, bis(4-hydroxyphenyl)-cyclohexylmethane, 4,4′-dihydroxydiphenyl, 2,2′-dihydroxydiphenyl, 4,4′-dihydroxydiphenyl sulfone and the hydroxyethyl ethers thereof; phenol-formaldehyde condensation products such as phenol alcohols and phenol-aldehyde resins; S- and N-containing epoxides, for example N,N-diglycidylaniline and N,N′-dimethyldiglycidyl-4,4-diaminodiphenylmethane; and epoxides that have been prepared by customary methods from polyunsaturated carboxylic acids or monounsaturated carboxylic esters of unsaturated alcohols; glycidyl esters, and polyglycidyl esters, which can be obtained by polymerization or copolymerization of glycidyl esters of unsaturated acids or from other acidic compounds, for example from cyanuric acid, diglycidyl sulfide or cyclic trimethylene trisulfone or derivatives thereof.

The epoxy compound is more preferably selected from the group consisting of butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, hexane-1,6-diol diglycidyl ether, polypropylene glycol diglycidyl ether, trimethylolpropane triglycidyl ether, bisphenol A diglycidyl ether, bisphenol F diglycidyl ether and 3,4-epoxycyclohexylmethyl 3,4-epoxycyclohexanecarboxylate (UVACure 1500).

In one embodiment are the poly(meth)acrylates with at least one organosilane conforming to the formula (2)

R¹—Si(OR²)ₙR³ₘ (2)

in which R¹ is a radical containing an epoxy group,
the R² radical is each independently an alkyl or acyl radical,
R³ is a hydroxy group or an alkyl radical,
n is 2 or 3 and m is the result of 3-n.

In this case, there may be either crosslinking of reactive groups of the crosslinkable poly(meth)acrylates with the epoxy groups or condensation reactions of the hydrolyzable silyl groups of the organosilanes conforming to the formula (2) with one another. In this way, the organosilanes conforming to the formula (2) enable linkage of the poly(meth)acrylates to one another, and they are incorporated into the network formed.

The R¹ radical in the formula (2) preferably contains an epoxide or oxetane group as epoxy group. More preferably, R¹ contains a glycidyloxy, 3-oxetanylmethoxy or epoxycyclohexyl group. Likewise preferably, R¹ is an alkyl or alkoxy radical which contains an epoxy or oxetane group and has 2 to 12 carbon atoms. R¹ is especially selected from the group consisting of a 3-glycidyloxypropyl radical, a 3,4-epoxycyclohexyl radical, a 2-(3,4-epoxycyclohexyl)ethyl radical and a 3-[(3-ethyl-3-oxetanyl)methoxy]propyl radical.

The R² radicals in the formula (2) are preferably each independently an alkyl group, more preferably each independently a methyl, ethyl, propyl or isopropyl group, and most preferably each independently a methyl or ethyl group. This is advantageous because alkoxy groups and especially methoxy and epoxy groups can be hydrolyzed readily and rapidly, and the alcohols formed as cleavage products can be removed comparatively easily from the composition and do not have a critical toxicity.

R³ in the formula (2) is preferably a methyl group.

The at least one organosilane conforming to the formula (2) is more preferably selected from the group consisting of (3-glycidyloxypropyl)trimethoxysilane, (3-glycidyloxypropyl)triethoxysilane, (3-glycidyloxypropyl)methyldimethoxysilane, (3-glycidyloxypropyl)methyldiethoxysilane, 5,6-epoxyhexyltriethoxysilane, [2-(3,4-epoxycyclohexyl)ethyl]trimethoxysilane, [2-(3,4-epoxy-cyclohexyl)ethyl]triethoxysilane and triethoxy[3-[(3-ethyl-3-oxetanyl)methoxy]propyl]silane.

More preferably, the poly(meth)acrylates are crosslinked by means of a crosslinker-accelerator system (“crosslinking system”), in order to obtain better control over the processing time, crosslinking kinetics and degree of crosslinking. The crosslinker-accelerator system preferably comprises at least one substance containing at least two epoxy groups as crosslinker, and at least one substance having accelerating action at a temperature below the melting temperature of the polymer to be crosslinked for crosslinking reactions by means of compounds containing epoxy groups as accelerator.

Accelerators used in accordance with the invention are more preferably amines. These should be regarded in a formal sense as substitution products of ammonia; in the formulas that follow, the substituents are represented by “R” and especially include alkyl and/or aryl radicals. Particular preference is given to using those amines that enter into only a low level of reactions, if any, with the polymers to be crosslinked.

In principle, accelerators chosen may be primary (NRH₂), secondary (NR₂H) or else tertiary amines (NR₃), and of course also those having multiple primary and/or secondary and/or tertiary amino groups. Particularly preferred accelerators are tertiary amines, especially triethylamine, triethylenediamine, benzyldimethylamine, dimethylaminomethylphenol, 2,4,6-tris(N,N-dimethylaminomethyl)phenol and N,N′-bis(3-(dimethylamino)propyl)urea; and further polyfunctional amines, especially diethylenetriamine, triethylenetetramine and trimethylhexamethylenediamine.

Further preferred accelerators are amino alcohols, especially secondary and/or tertiary amino alcohols, where, in the case of multiple amino functionalities per molecule, preferably at least one amino functionality is and more preferably all amino functionalities are secondary and/or tertiary. Particularly preferred accelerators of this kind are triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)propane-1,3-diol, 1-[bis(2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethyl bisaminoethyl ether, N,N,N′-trimethylaminoethylethanolamine and N,N,N′-trimethylaminopropylethanolamine.

Further suitable accelerators are pyridine, imidazoles, for example 2-methylimidazole, and 1,8-diazabicyclo[5.4.0]undec-7-ene. It is also possible to use cycloaliphatic polyamines as accelerator. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerator; examples are tetrabutylammonium hydroxide, cetyltrimethylammonium bromide and benzalkonium chloride.

Irrespective of any thermal crosslinking, the poly(meth)acrylates may also be crosslinked by customary methods with electron beams (EBC).

In one embodiment, the polymerization of the (meth)acrylate monomers is effected with UV initiation only up to a degree of polymerization at which there is a mixture of polymers and monomers. This generally syrup-like mixture is then compounded with the further components of the pressure-sensitive adhesive, and only after the mass has been shaped to a sheet, further polymerized or crosslinked by UV irradiation. In this variant, it is thus not the finished (fully polymerized) polymers that are used in the compounding of the pressure-sensitive adhesive, but rather a mixture of polymers and monomers, wherein the monomers also fulfill the function of a solvent for the polymers.

The pressure-sensitive adhesive of the invention may comprise further polymers as well as the poly(meth)acrylate or the poly(meth)acrylates. In one embodiment, the pressure-sensitive adhesive of the invention comprises at least one further polymer selected from silicones and rubbers.

Preferably useful among the silicones are organopolysiloxanes that are typically used in silicone-based pressure-sensitive adhesives.

The rubbers are preferably selected from natural rubbers and synthetic rubbers, the latter preferably being selected from copolymers based on vinylaromatics and conjugated dienes having 4 to 18 carbon atoms and/or isobutylene, nitrile rubbers and ethylene-propylene elastomers.

The pressure-sensitive adhesive of the invention contains a mixture of at least two fillers in an amount of at least 40% by volume, where this mixture comprises at least one filler Fiₛₚₕ consisting of essentially spherical particles. As has been found, such a filler mixture is capable of bringing about particular properties of the adhesive tape in a largely direction-independent manner, i.e. of countering anisotropy.

The filler mixture preferably brings about thermal conductivity of the pressure-sensitive adhesive, which is weakly anisotropic or not anisotropic at all. The filler mixture thus preferably comprises at least one thermally conductive filler. In particular, at least the filler consisting of essentially spherical particles is a thermally conductive filler.

A “thermally conductive filler” is especially understood to mean a filler having a thermal conductivity of at least 1 W/(m*K), more preferably of at least 3 W/(m*K).

“Essentially spherical pellets” are understood to mean particles that are not necessarily of ideal spherical shape, but would be best described as spheres. More particularly, this is understood to mean particles in which the lengths of all straight lines that connect to points on the particle surface and run through the geometric center of the particle differ from one another by not more than 15%, more preferably by not more than 10%. In an ideal sphere, all these lines are of identical length.

The filler Fiₛₚₕ preferably has a particle size distribution, determined by means of laser diffraction (red laser, 830 nm) on a sample of 0.40 g in 1 l of deionized water (dispersant: 1 g Na₄P₂O₇×10 H₂O ultrapure) and reported with reference to the numerically evaluated distribution of the diameters D(n), of d50=1.5-23*d10 and d90=36-75*d10. More preferably, the filler Fiₛₚₕ has a particle size distribution, determined by means of laser diffraction (red laser, 830 nm) on a sample of 0.40 g in 1 l of deionized water (dispersant: 1 g Na₄P₂O₇×10 H₂O ultrapure) and reported with reference to the numerically evaluated distribution of the diameters D(n), of d10=0.8-1.1 μm, d50=2-18 μm and d90=40-60 μm. As has been shown, given such a broad particle size distribution of the essentially spherical particles of the filler Fiₛₚₕ, it is possible to achieve very high levels of filling. It has been observed that, even with fillers of intrinsically weaker thermal conductivity, it is possible here to achieve very good thermal conductivities of the pressure-sensitive adhesives filled therewith.

The filler Fiₛₚₕ preferably has a thermal conductivity of not more than 50 W/(m*K), more preferably of not more than 30 W/(m*K), especially of not more than 15 W/(m*K). In many cases, this advantageously corresponds to a low electrical conductivity, such that the fillers in question, aside from their thermal conductivity, show properties of an electrical insulator, or impart properties of an electrical insulator to the pressure-sensitive adhesive.

For the further filler in the filler mixture of the pressure-sensitive adhesive of the invention too, electrical insulation properties are desirable. In particular, the totality of the fillers of the pressure-sensitive adhesive of the invention is electrically insulating. More preferably, the pressure-sensitive adhesive of the invention is electrically insulating.

An electrical insulator is considered to be a substance having a specific resistivity of ≥10⁸ Ω*cm to TRGS 727.

In one embodiment, only the filler Fiₛₚₕ consists of essentially spherical particles. The second filler in the mixture of at least two fillers, or the totality of the further fillers in the mixture of at least two fillers, in this case consists of particles that are not essentially spherical. For example, the second filler in the mixture consists of at least two fillers, or the totality of the further fillers in the mixture consists of at least two fillers, in this case composed of round (but not essentially spherical) irregular polyhedral, irregular polygonal or platelet-shaped particles; more particularly, the second filler in the mixture consists of at least two fillers, or the totality of the further fillers in the mixture consists of at least two fillers, composed of platelet-shaped particles.

Preferably, only the filler Fiₛₚₕ consists of essentially spherical particles and is present in a weight excess over the further filler or the totality of further fillers. More preferably, this weight excess is 1.1:1 to 20:1, especially 2:1 to 15:1, for example 5:1 to 12:1 and most preferably 7:1 to 11:1.

The filler Fiₛₚₕ preferably consists of aluminum oxide or aluminum hydroxide; in particular, it consists of aluminum hydroxide and hence of essentially spherical aluminum hydroxide particles.

The pressure-sensitive adhesive of the invention preferably comprises boron nitride as a further filler in addition to Fiₛₚₕ. Most preferably, the mixture of at least two fillers consists of aluminum hydroxide and boron nitride, with the aluminum hydroxide in the form of essentially spherical particles.

The pressure-sensitive adhesive of the invention contains the mixture of at least two fillers preferably in an amount of at least 50% by volume, more preferably in an amount of at least 55% by volume, especially in an amount of at least 60% by volume, based in each case on the total volume of the pressure-sensitive adhesive.

With regard to the proportion by weight, the pressure-sensitive adhesive of the invention contains the mixture of at least two fillers preferably in an amount of at least 60% by weight, more preferably in an amount of at least 65% by weight, especially in an amount of at least 70% by weight, based in each case on the total weight of the pressure-sensitive adhesive.

According to the field of use and desired properties of the pressure-sensitive adhesive of the invention, it may comprise further components and/or additives, specifically in each case alone or in combination with one or more other additives or components.

The pressure-sensitive adhesive of the invention may comprise at least one tackifier, which may also be referred to as bond strength enhancer or tackifying resin. A “tackifier”, in accordance with the general understanding of the person skilled in the art, is understood to mean an oligomeric or polymeric resin that increases the autoadhesion (tack, self-adhesiveness) of the pressure-sensitive adhesive compared to the pressure-sensitive adhesive that does not comprise any tackifier but is otherwise identical.

The tackifier preferably has a DACP value of less than 0° C., very preferably of not more than −20° C., and/or preferably an MMAP value of less than 40° C., very preferably of not more than 20° C. With regard to the determination of DACP and MMAP values, reference is made to C. Donker, PSTC Annual Technical Seminar, Proceedings, p. 149-164, May 2001.

In one embodiment, the tackifier is a terpene phenolic resin or a rosin derivative, especially a terpene phenolic resin. The pressure-sensitive adhesive of the invention may also comprise mixtures of two or more tackifiers. Among the rosin derivatives, preference is given to rosin esters.

The pressure-sensitive adhesive of the invention preferably contains tackifier in a total amount of 2% to 15% by weight, more preferably in a total amount of 4% to 10% by weight, based in each case on the total weight of the pressure-sensitive adhesive.

The pressure-sensitive adhesive of the invention preferably comprises one or more plasticizers. The plasticizer is preferably selected from the group consisting of phthalates, hydrocarbon oils, cyclohexanedicarboxylic esters, water-soluble plasticizers, tackifying resins, phosphates and polyphosphates. The plasticizer is more preferably a cyclohexanedicarboxylic ester, especially diisononyl cyclohexanedicarboxylate (DINCH). The pressure-sensitive adhesive of the invention preferably contains plasticizer in a total amount of 0.5% to 10% by weight, more preferably in a total amount of 0.8% to 7% by weight, based in each case on the total weight of the pressure-sensitive adhesive.

In one embodiment, the pressure-sensitive adhesive of the invention comprises at least one (meth)acrylate oligomer. (Meth)acrylate oligomers can advantageously endow the poly(meth)acrylate-based pressure-sensitive adhesive of the invention with bond strength-enhancing and plasticizing properties. They are therefore counted both among the tackifiers preferred in accordance with the invention and among the plasticizers preferred in accordance with the invention.

The pressure-sensitive adhesive of the invention may comprise one or more (meth)acrylate oligomers. The pressure-sensitive adhesive of the invention preferably contains (meth)acrylate oligomers in a total amount of 0.5-15% by weight, especially in a total amount of 1-10% by weight, based in each case on the total weight of the pressure-sensitive adhesive.

Moreover, the pressure-sensitive adhesive of the invention may comprise low-flammability fillers, for example ammonium polyphosphates; carbon fibers and/or silver-coated spheres; ferromagnetic additives, for example iron(III) oxides; organic renewable raw materials, for example sawdust; organic and/or inorganic nanoparticles; foaming agents, fibers, compounding agents, ageing stabilizers, light stabilizers, colorants and/or antiozonants.

In one embodiment, the pressure-sensitive adhesive of the invention comprises colorants, especially pigments and/or carbon black.

In a further embodiment, the pressure-sensitive adhesive of the invention has been foamed. The foaming may in principle have been brought about in any customary manner; preferably, the pressure-sensitive adhesive comprises microbeads, especially hollow glass beads, solid glass beads, hollow ceramic beads and/or at least partly expanded hollow microbeads. The latter are elastic hollow microbeads that are thus expandable in their ground state, which have a thermoplastic polymer shell and are filled with low-boiling liquids or liquefied gas, and hence can expand when heated.

The pressure-sensitive adhesive of the invention may in principle be produced in any desired manner. It is preferably produced in a continuous process.

In one embodiment, the pressure-sensitive adhesive of the invention is produced from the adhesive melt. This method may firstly comprise a concentration step on the poly(meth)acrylate solution or dispersion resulting from the polymer preparation. The concentration of the polymer can be accomplished in the absence of crosslinker and accelerator substances. But it is also possible to add not more than one of these substances to the polymer even before the concentration, such that the concentration is then effected in the presence of this substance.

In the simplest case, the compounding, i.e. the blending of the poly(meth)acrylate with the further constituents of the pressure-sensitive adhesive, is conducted in a kneader. This involves introducing all components of the pressure-sensitive adhesive apart from the crosslinker or accelerator into the kneader at the same time or successively and incorporating them into the adhesive. The adhesive can be shaped to a sheet, for example, by means of a roll mill.

The production of the pressure-sensitive adhesive from the adhesive melt preferably comprises passage through a compounding and extrusion apparatus. Any piece of equipment used for concentration of the adhesive may or may not form part of this compounding and extrusion apparatus. After passing through the compounding and extrusion apparatus, the pressure-sensitive adhesive is preferably in the form of a melt.

The fillers and any tackifier resins may be added to a compounder via a solids metering device. A side feeder can be used to introduce the concentrated and optionally already molten poly(meth)acrylate into the compounder. In particular executions of the process, it is also possible for concentration and compounding to take place in the same reactor. Resins may optionally also be fed in via a resin melt and a further side feeder at a different position in the process, for example downstream of the introduction of the poly(meth)acrylate.

Further additives and/or plasticizers may likewise be fed in as solids or a melt or else as a batch in combination with another formulation component.

In particular, an extruder is used as a compounder or as a constituent of the compounding and extrusion apparatus. The polymers are preferably in molten form in the compounder, either because they are introduced already in the molten state or in that they are heated to melting in the compounder. Advantageously, the poly(meth)acrylates are kept in the melt in the compounder by heating.

If accelerator substances for the crosslinking of the poly(meth)acrylate are used, these are preferably added to the polymers only shortly before further processing, especially shortly before coating or another shaping operation. The time window for the addition prior to coating is guided especially by the pot life available, i.e. the processing time in the melt, without any adverse change in the properties of the resulting product.

The crosslinkers, for example epoxides, and optionally the accelerators may also both be added shortly prior to the processing of the composition, i.e. advantageously in the phase as described above for the accelerators. For this purpose, it is advantageous when crosslinker and accelerator are introduced into the process simultaneously at one and the same point, optionally as an epoxide-accelerator blend. In principle, it is also possible to switch the junctures of addition or addition points for crosslinker and accelerator in the executions described above, such that the accelerator can be added before the crosslinker substances.

After the compounding and the discharge of the finished pressure-sensitive adhesive, the pressure-sensitive adhesive is shaped to a sheet, preferably in a calender nip. The coating calender may consist here of two, three, four or more rolls. Preferably at least one of the rolls has been provided with an anti-adhesive roll surface. More preferably, all rolls of the calender that come into contact with the pressure-sensitive adhesive have an anti-adhesive finish. An anti-adhesive roll surface used with preference is a steel-ceramic-silicone composite. Such roll surfaces are resistant to thermal and mechanical stresses.

It has been found to be particularly advantageous when roll surfaces having a surface structure are used, especially in such a way that the surface does not establish complete contact with the adhesive layer to be processed, such that the contact area is smaller—compared to a smooth roll. Structured rolls such as patterned metal rolls are particularly favorable, for example patterned steel rolls.

It is also possible to discharge the finished adhesive by means of a nozzle.

Coating can be effected onto a temporary carrier. A temporary carrier is removed later on in the processing operation, for example in the finishing of the adhesive tape, or on application of the adhesive layer. The temporary carrier is preferably a release liner. The pressure-sensitive adhesive may also be covered on each side with a temporary carrier or with a release liner.

The invention further provides for the use of the pressure-sensitive adhesive of the invention for conduction of heat, preferably for conduction of heat in energy storage means; switched-mode power supply units, e.g. DC-DC converters, AC-DC converters; rectifiers; frequency converters; and/or power electronics components, for example power transistors, power diodes and/or high-power LEDs.

Particular preference is given to using the pressure-sensitive adhesive of the invention for conduction of heat and electrical insulation, especially for conduction of heat and electrical insulation in energy storage means; switched-mode power supply units, e.g. DC-DC converters, AC-DC converters; rectifiers; frequency converters; and/or power electronics components, for example power transistors, power diodes and/or high-power LEDs.

### EXAMPLES

### Test Methods

### Method 1: Bond Strength on Aluminum

The bond force was determined under test conditions of temperature 23° C.+/−1° C. and rel. air humidity 50%+/−5%. The specimens were cut to a width of 20 mm and stuck to an aluminum plate. The aluminum plate was cleaned and conditioned prior to the measurement. For this purpose, the plate was first wiped with solvent and then left exposed for 5 minutes for the solvent to be able to evaporate off. The side of the adhesive tape remote from the test substrate was then covered with 75 μm-thick etched PET film, which prevented the specimen from expanding during the measurement. Thereafter, the test specimen was rolled onto the substrate. For this purpose, the tape was rolled five times back and forth with a 4 kg roll at a rolling speed of 10 m/min. Three days after the rolling, the plate was inserted into a special holder that enables the specimen to be pulled off at an angle of 90°. The bond force was measured with a Zwick tensile tester. The measurement results are reported in N/cm and are the average of five individual measurements.

### Method 2: Thermal Conductivity in z Direction

Thermal conductivity was measured to ASTM D5470 (through-plane) with the LW-9389 model from the manufacturer LonGwin.

### Method 3: Particle Size Distribution

Particle size distribution was determined by laser diffraction, using a “Cilas 1064” laser granulometer. The device has a measurement range of 0.04-500 μm, divided into 100 classes. 0.40 g of the filler to be examined was weighed into the cuvette provided and dispersed using the device's ultrasound function in 1000 ml of deionized water containing 1 g of Na₄P₂O₇×10 H₂O ultrapure for 60 s.

The sample was then irradiated with a red laser of wavelength 830 nm. The grain distribution was derived from the intensity of diffraction of the laser light (evaluation according to Fraunhofer).

### Method 4: Electrical Resistivity

Measurements of surface resistivity and volume resistivity were made on the pressure-sensitive adhesives. Measurement was effected with a Milli-TO 3 from Fischer Elektronik (S/N 1005651) with guard ring electrode according to DIN IEC 60093 and DIEN IEC 60167.

### Preparation of the Polymers

### Copolymer 1:

A conventional reactor for free-radical polymerizations was charged with 67.0 kg of n-butyl acrylate, 30.0 kg of 2-ethylhexyl acrylate, 3.0 kg of acrylic acid and 66.6 kg of acetone/isopropanol (94:6). After passing nitrogen gas through for 45 minutes while stirring, the reactor was heated up to 58° C., and 50 g of AIBN dissolved in 500 g of acetone was added. Subsequently, the external heating bath was heated to 75° C. and the reaction was conducted constantly at this exterior temperature. After 1 h another 50 g of AIBN dissolved in 500 g of acetone was added, and after 4 h the mixture was diluted with 10 kg of acetone/isopropanol mixture (94:6).

After 5 h and after 7 h, further initiator was respectively supplied in the form of 150 g of bis(4-tert-butylcyclohexyl) peroxydicarbonate, each time dissolved in 500 g of acetone. After a reaction time of 22 h, the polymerization was stopped and cooled down to room temperature. The product had a solids content of 55.8% and was dried. The resulting polyacrylate had an average molecular weight M_{w} of 605000 g/mol, a polydispersity D (Mw/Mn) of 4.27 and a static glass transition temperature T_{g} of −45° C.

### Copolymer 2:

A reactor was initially charged with a monomer mixture consisting of 67 kg of n-butyl acrylate, 30 kg of ethylhexyl acrylate and 3 kg of acrylic acid, and also 0.15 kg of Irgacure 651 (manufacturer: Ciba), and the mixture was stirred under inert atmosphere and irradiated with a mercury vapor lamp at a UV dose of 12 mW/cm² for 10 min, such that a viscous mass formed therefrom. The syrupy copolymer-monomer mixture obtained in this way was then used in the subsequent production experiments.

Further components of the pressure-sensitive adhesives:
Plasticizer: diisononyl cyclohexane-1,2-dicarboxylate, commercially available under the Hexamoll Dinch name (BASF)
Filler 1: aluminum hydroxide, commercially available under the Apyral 20× name (Nabaltec AG); d10=0.8-1.1 μm; d50=2-18 μm; d90=40-60 μm
Filler 2: boron nitride platelets, commercially available under the Polartherm PT 131 name (Momentive USA)
Filler 3: hexagonal aluminum hydroxide, commercially available under the Martinal OL 104-LEO name (Huber Martinswerk)
Crosslinker 1: pentaerythritol tetraglycidyl ether, commercially available under the 749 Epoxy Dullent name (DOW)
Crosslinker 2: [3-(2,3-epoxypropoxy)propyl]triethoxysilane, commercially available under the Dynasilan GLYEO name (Evonik)
Crosslinker 3: tris(2,4-pentanedione)aluminum(III), commercially available, TCI-Chemicals product number A0241, 8.7% in acetone
Crosslinker 4: hexane-1,6-diol acrylate, commercially available under the Ebecryl 7100 name (Cytec Surface Specialties)
Accelerator 1: isophoronediamine, commercially available under the Vestamin IPD name (Evonik)
Accelerator 2: 3-aminopropyltriethoxysilane, commercially available under the Dynasilan AMEO name (Evonik).

### Production of the Pressure-Sensitive Adhesives

Pressure-sensitive adhesives 1 to 6 were compounded using a Z kneader having a nameplate volume of 1500 cm³. The resultant compositions were shaped to a layer with a Lauter hot press; the roll nip was set to 1000 μm by means of spacer screws.

UV curing of the pressure-sensitive adhesives produced with copolymer 2

The UV curing was conducted in a black box with black light lamps from Sylvania. The UV dose set was 6 mW/cm².

Irradiation was as follows: 3×30 s with a gap of 30 s between the respective irradiations; then 3×60 s with a gap of 30 s between the respective irradiations; followed by irradiation from each side for 300 s.

### Pressure-Sensitive Adhesive 1

The kneader was initially charged with 198 g of copolymer 1 and heated to 160° C. While mixing constantly, 46.2 g of filler 2 was added in portions and incorporated homogeneously, followed by 416 g of filler 1, likewise in portions. A total of 9.9 g of plasticizer 1 was incorporated homogeneously into the adhesive in two steps. After a further 15 minutes, 2.5 g of crosslinker 3 was added dropwise and incorporated homogeneously within 5 min. The adhesive was removed from the kneader while still hot and shaped to a 1000 μm-thick layer.

### Pressure-Sensitive Adhesive 2

The kneader was initially charged with 120 g of copolymer 1 and heated to 160° C. While mixing constantly, 48 g of filler 2 was added in portions and incorporated homogeneously, followed by 432 g of filler 1, likewise in portions. A total of 6 g of plasticizer 1 was incorporated homogeneously into the adhesive in two steps. After a further 15 minutes, 1.5 g of crosslinker 3 was added dropwise and incorporated homogeneously within 5 min. The adhesive was removed from the kneader while still hot and shaped to a 1000 μm-thick layer.

### Pressure-Sensitive Adhesive 3

The kneader was initially charged with 98 g of copolymer 1 and heated to 160° C. While mixing constantly, 88 g of filler 2 was added in portions and incorporated homogeneously, followed by 250 g of filler 1, likewise in portions. A total of 32 g of plasticizer 1 was incorporated homogeneously into the adhesive in two steps. After a further 15 minutes, 1.25 g of crosslinker 3 was added dropwise and incorporated homogeneously within 5 min. The adhesive was removed from the kneader while still hot and shaped to a 1000 μm-thick layer.

### Pressure-Sensitive Adhesive 4

Under yellow light, the kneader was initially charged with 198 g of the syrupy copolymer 2 and heated to 60° C. While mixing constantly, 46.2 g of filler 2 was added in portions and incorporated homogeneously, followed by 416 g of filler 1, likewise in portions. A total of 9.9 g of plasticizer 1 was incorporated homogeneously into the adhesive in two steps. The adhesive was removed from the kneader while still hot, shaped to a 1000 μm-thick layer and then cured as described above.

### Pressure-Sensitive Adhesive 5

Under yellow light, the kneader was initially charged with 120 g of the syrupy copolymer 2 and heated to 60° C. While mixing constantly, 48 g of filler 2 was added in portions and incorporated homogeneously, followed by 432 g of filler 1, likewise in portions. 6 g of plasticizer 1 was incorporated homogeneously into the adhesive. The adhesive was removed from the kneader while still hot, shaped to a 1000 μm-thick layer and then cured as described above.

### Pressure-Sensitive Adhesive 6

Under yellow light, the kneader was initially charged with 98 g of the syrupy copolymer 2 and heated to 60° C. While mixing constantly, 88 g of filler 2 was added in portions and incorporated homogeneously, followed by 250 g of filler 1, likewise in portions. 32 g of plasticizer 1 was incorporated homogeneously into the adhesive in portions. The adhesive was removed from the kneader while still hot, shaped to a 1000 μm-thick layer and then cured as described above.

Pressure-Sensitive Adhesives 7 to 12 were Produced by the Following Method:

### Step 1: Concentration

The base polymer P (copolymer 1 or 2) was very substantially freed of solvent (residual solvent content 0.3% by weight) by means of a single-screw extruder (concentrating extruder, Berstorff GmbH, Germany). The parameters for the concentration of the base polymer were as follows: screw speed 150 rpm, motor current 15 A; a throughput of 58.0 kg/h of liquid was achieved. For the concentration, a vacuum was applied to three different domes. The reduced pressures were each between 20 mbar and 300 mbar. The exit temperature of the concentrated hotmelt P was about 115° C. The solids content after this concentration step was 99.8%.

Step 2: Production of the Pressure-Sensitive Adhesive—Blending with the Further Components

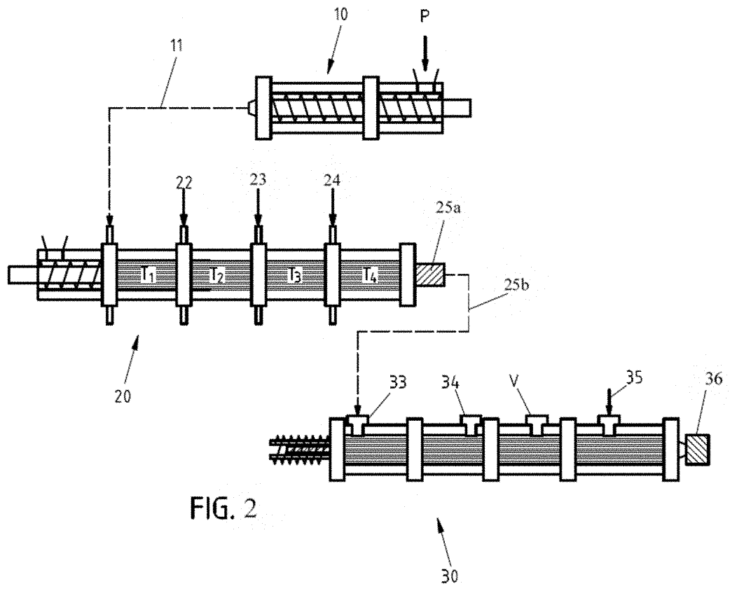

This step was conducted in a pilot plant corresponding to the diagram in FIG. 2.

The base polymer P was melted in the concentrating extruder 10 as per step 1 and conveyed thereby as polymer melt through a heatable hose 11 into a planetary roll extruder 20 (PRE) from ENTEX (Bochum) (more particularly, a PRE having four independently heatable modules T1, T2, T3, T4 was used). The plasticizer was fed in at the metering orifice 22, and the filler 1 at metering orifices 23 and 24. All components were mixed to give a homogeneous polymer melt.

By means of a melt pump 25a and a heatable hose 25b, the polymer melt was transferred into a twin-screw extruder 30 (from BERSTORFF) (introduction position 33). At position 34, crosslinker and accelerator were added. Subsequently, the entire mixture was freed of all trapped gas in a vacuum dome V at a pressure of 175 mbar. Thereafter, at position 35, the filler 2 was added and subsequently incorporated homogeneously. The resultant melt mixture was transferred to the outlet 36.

The adhesive was shaped while still hot as described above to give a 1000 μm-thick layer.

Constituents and amounts for the production of the pressure-sensitive adhesives can be found in table 1 below. The amounts supplied are reported in the relevant units per hour owing to the continuous procedure.

### Table 1: Pressure-Sensitive Adhesives 7-12—Constituents and Amounts

TABLE 1
Pressure-sensitive adhesives 7-12-constituents and amounts

| PSA No. | 7 | 8 | 9 | 10 | 11 | 12 | 13 (comp.) |
|---|---|---|---|---|---|---|---|
| Copolymer 1 (kg/h) | 20.95 | 20.95 | 19.8 | 19.8 | 20.94 | 20.94 | 20.95 |
| Filler 1 (kg/h) | 62.1 | 62.1 | 71.29 | 71.29 | 53.42 | 53.42 | |
| Filler 2 (kg/h) | 6.9 | 6.9 | 7.92 | 7.92 | 18.8 | 18.8 | |
| Filler 3 (kg/h) | | | | | | | 14.95 |
| Crosslinker 1 (ml/h) | 25.34 | | 23.95 | | 25.33 | | 25.34 |
| Crosslinker 2 (ml/h) | | 27.0 | | 25.49 | | 26.95 | |
| Accelerator 1 (ml/h) | 227.72 | | 215.22 | | 227.61 | | 227.72 |
| Accelerator 2 (ml/h) | | 66.16 | | 62.53 | | 66.13 | |
| Plasticizer 1 (kg/h) | 1.48 | 1.48 | 0.99 | 0.99 | 6.84 | 6.84 | 1.48 |

PSA = pressure-sensitive adhesive
comp. = Comparative example

PSA=pressure-sensitive adhesive
comp.=Comparative example

The test results achieved with the pressure-sensitive adhesives produced are given in table 2.

### Table 2: Test Results

TABLE 2
Test results

| | Thermal | |
|---|---|---|
| Pressure- | conductivity | Bond |
| sensitive | in z | strength on |
| adhesive | direction | aluminum |
| No. | (W/(m*K) | (N/cm) |
| 1 | 0.72 | 15 |
| 2 | 1.2 | 7.8 |
| 3 | 2.5 | 3 |
| 4 | 0.6 | 11 |
| 5 | 0.9 | 5.5 |
| 6 | 2.1 | 0.5 |
| 7 | 0.75 | 14 |
| 8 | 0.72 | 15 |
| 9 | 1.21 | 8.2 |
| 10 | 1.19 | 8.5 |
| 11 | 2.48 | 3 |
| 12 | 2.53 | 3.5 |
| 13 (comp.) | 0.4 | 15.8 |

For all pressure-sensitive adhesive compositions, electrical volume resistances of 4.94*10¹³ to 5.21*10¹⁴ Ω*cm were measured.

1. A pressure-sensitive adhesive comprising
a. at least one poly(meth)acrylate;
b. at least 40% by volume, based on a total volume of the pressure-sensitive adhesive, of a mixture of at least two fillers,
wherein the mixture of at least two fillers comprises at least one filler Fiₛₚₕ consisting of essentially spherical particles.

2. The pressure-sensitive adhesive of claim 1, wherein the at least one filler Fiₛₚₕ has a particle size distribution, determined by laser diffraction (red laser, 830 nm) on a sample of 0.40 g in 1 l of deionized water (dispersant: 1 g Na₄P₂O₇×10 H₂O ultrapure) and reported with reference to the numerically assessed distribution of diameters D(n), of d50=1.5-23*d10 and d90=36-75*d10.

3. The pressure-sensitive adhesive of claim 1, wherein only the at least one filler Fiₛₚₕ consists of essentially spherical particles and is present in a weight excess with respect to the further filler or the entirety of the further fillers.

4. The pressure-sensitive adhesive of claim 3, wherein the weight excess is 2:1 to 15:1.

5. The pressure-sensitive adhesive of claim 1, wherein the at least one filler Fiₛₚₕ consists of aluminum oxide or aluminum hydroxide.

6. The pressure-sensitive adhesive of claim 5, wherein the at least one filler Fiₛₚₕ consists of aluminum hydroxide.

7. The pressure-sensitive adhesive of claim 1, wherein the pressure-sensitive adhesive comprises boron nitride as a further filler in addition to the at least one filler Fiₛₚₕ.

8. The pressure-sensitive adhesive of claim 1, wherein the pressure-sensitive adhesive contains the mixture of at least two fillers to an extent of at least 60% by volume.

9. The pressure-sensitive adhesive of claim 1, wherein the pressure-sensitive adhesive contains poly(meth)acrylates in a total amount of 10% to 30% by weight, based on a total weight of the pressure-sensitive adhesive.

10. An electronic device comprising the pressure-sensitive adhesive of claim 1.

11. A method comprising:
connecting a cooling plate and single cells of at least one multiple interconnected electrochemical assembly such that an adhesive tape comprising the pressure-sensitive adhesive of claim 1 provides connection between the cooling plate and the single cells.
